(19) United States
(12) Patent Application Publication
(10) Pub. No.: US 2025/0354572 A1
(43) Pub. Date: Nov. 20, 2025

(54) Clamp and Base System for Ceiling Fan Filter

(71) Applicant: Crestwood Capital, LLC doing business as (d.b.a.) Barnakl, Virginia Beach, VA (US)

(72) Inventors: Peter Finlay, Virgina Beach, VA (US); Kevin Finlay, Virginia Beach, VA (US); Paul Finlay, Virginia Beach, VA (US)

(21) Appl. No.: 19/212,329

(22) Filed: May 19, 2025

Related U.S. Application Data
(60) Provisional application No. 63/649,804, filed on May 20, 2024.

(51) Int. Cl. F16B 2/10; B01D 46/42; F24F 8/108; F24F 13/28

(52) U.S. Cl. CPC F16B 2/10; B01D 46/4227; F24F 8/108; F24F 13/28; B01D 2265/028; B01D 2273/30; F24F 2221/14

(57) ABSTRACT

Provided herein is an air purification device that has a base plate for attaching to a blade of a fan and a clamp to secure an air purification filter to the base plate. The base plate includes a distally directed receiving slot. The clamp includes a stationary jaw having a peg that is insertable into the distally directed receiving slot of the base plate and a hinging jaw that uses a hinging mechanism to mechanically-bias the hinging jaw towards the stationary jaw, wherein the air purification filter is secured between the hinging jaw and the stationary jaw, and wherein the stationary jaw and the hinging jaw are in opposable contact fixed by a hinging mechanism and having a force that resists separation of the hinging jaw from the stationary jaw.

### CROSS-REFERENCE TO RELATED APPLICATIONS

The present application claims priority to provisional U.S. Application No. 63/649,804 filed May 20, 2024, the contents of which are hereby incorporated by reference in their entirety.

### BACKGROUND

It can be desirable to eliminate impurities from the air in both residential and commercial settings, as these impurities can have adverse health effects, as well as other negative consequences. For example, dust, pollen, pet dander, mold spores, dust mites, ragweed, and the like can be allergens, triggering allergies in sensitive people. Airborne smoke particles and volatile organic compounds (VOCs) can also pose a health risk. In the atmosphere, ammonia can bind to other gases to form ammonium which has particularly negative impacts on cardiovascular and respiratory health systems, as well as creating a direct toxic effect on vegetation. An air purifier or air cleaner can reduce these negative effects.

For example, existing air purifiers and air cleaners are devices that remove contaminants from the air to improve air quality. In existence are both private and commercial-grade air purifiers. Commercially graded air purifiers include either small stand-alone units or larger units that can be affixed to an air handler unit (AHU) or to a heating, ventilation, and air conditioning (HVAC) unit and can be found in the medical, industrial, and commercial industries. Standard air purification filters ensnare airborne particles by size exclusion—as air is forced through a filter, larger particles are physically captured by the filter. In existence are different types of air purifiers, such as ones targeted to remove specific types of contaminants and/or bacteria, but the basic principle is consistently to bring in dirty air, pass it through different types of filters to sanitize the air, and release the clean air back into the environment.

Existing air purification structures and techniques are limited, both in terms of quality and accessibility. Personal air purification devices, such as for residential use, can be very costly, use a lot of energy, take up a lot of space, be excessively loud, or be bulky and visually displeasing. Commercial-grade air purification devices can also be expensive, hard to clean, and hard to change for clean, effective filtration.

Unless otherwise indicated herein, the description in this section is not believed to be prior art to the claims in this application and is not admitted to be prior art by inclusion in this section.

### SUMMARY

This disclosure generally relates to a device including a clamp for an air purification filter and a base plate. The clamp and the base plate can be coupled to one another. The base plate can be semi-permanently attached to a blade of a fan and the clamp can be removably coupled with the base plate. The clamp is also designed to have a stationary jaw and a hinging jaw between which is secured an air purification filter. The system, therefore, can secure the air purification filter inter alia to the fan blade.

In one embodiment, a clamp is disclosed. A stationary jaw of the clamp has a coupling member, a backstop that extends vertically from an interior surface of the stationary jaw, and a peg. A hinging jaw of the clamp has an exterior surface that includes an arched shape, a bridge on the exterior surface of the hinging jaw wherein the bridge is on a crest of the exterior surface, and an eye spanning a width of the bridge and disposed between the bridge and at least a portion of the exterior surface of the hinging jaw. The stationary jaw and the hinging jaw are in opposable contact fixed by a hinging mechanism and having a force that resists separation of the hinging jaw from the stationary jaw.

In another embodiment, a device is disclosed. The device includes a base plate having a length and a receiving slot that is distally directed. The device also includes a clamp. The clamp includes a stationary jaw having a coupling member, a backstop that extends vertically from an interior surface of the stationary jaw, and a peg. The clamp also includes a hinging jaw having an exterior surface that includes an arched shape, a bridge on the exterior surface of the hinging jaw wherein the bridge is on a crest of the exterior surface, and an eye spanning a width of the bridge and disposed between the bridge and at least a portion of the exterior surface of the hinging jaw. The stationary jaw and the hinging jaw are in opposable contact fixed by a hinging mechanism and having a force that resists separation of the hinging jaw from the stationary jaw.

In another embodiment, a method of attaching an air purification filter to a device for attaching the air purification filter to a fan blade is disclosed. The method includes securing the air purification filter in a clamp. Securing the air purification filter in the clamp includes applying pressure to a bridge of the clamp sufficient to overcome a biasing force of a hinging mechanism of the clamp, inserting the air purification filter between a stationary member and a hinging member of the clamp until the air purification filter abuts a backstop, and releasing the pressure on the bridge of the clamp. The method also includes inserting a peg of the clamp into a receiving slot of a base plate. Inserting a peg of the clamp into a receiving slot of a base plate includes aligning the peg with the receiving slot and sliding the clamp distally along the receiving slot until the clamp and the base plate are engaged.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1A is a sideview of a clamp, according to example embodiments.

FIG. 1B is a sideview of the clamp in FIG. 1A in an open position, according to example embodiments.

FIG. 1C is a perspective view of the clamp in FIG. 1A, according to example embodiments.

FIG. 1D is a top view of the clamp in FIG. 1A, according to example embodiments.

FIG. 1E is an exploded view of the clamp in FIG. 1A, according to example embodiments.

FIG. 1F is a section view of a portion of the clamp in Figure, according to example embodiments.

FIG. 1G is a perspective view of the clamp in FIG. 1A securing an air purification filter, according to example embodiments.

FIG. 2A is a top view of a base plate, according to example embodiments.

FIG. 2B is a bottom view of the base plate in FIG. 2A, according to example embodiments.

FIG. 2C is a side view of the base plate in FIG. 2A, according to example embodiments.

FIG. 3A is an illustration of a device having a clamp and a base plate, according to example embodiments.

FIG. 3B is an illustration of the device of FIG. 3A where the clamp and the base plate are assembled, according to example embodiments.

FIG. 3C is a side view of the device of FIG. 3A where the clamp and the base plate are assembled, according to example embodiments.

FIG. 3D is an illustration of the device of FIG. 3A where the clamp and the base plate are assembled with the base plate having a plurality of ridges in a waved configuration, according to example embodiments.

FIG. 3E is an additional view of the device of FIG. 3A, according to example embodiments.

FIG. 4A is an illustration of an air purification system including a fan, a device having a base plate and a clamp, and an air purification filter, according to example embodiments.

FIG. 4B is another view of the air purification system of FIG. 4A, according to example embodiments.

FIG. 4C is an illustration of the air purification filter being used by the air purification system of FIG. 4A, according to example embodiments.

FIG. 5A is an illustration of a tool configured to couple and decouple a clamp from a base plate, according to example embodiments.

FIG. 5B is an additional view of the tool of FIG. 5A, according to example embodiments.

FIG. 6A is an illustration of a tool aligning a clamp securing an air purification filter with a base plate secured to a blade of a fan, according to example embodiments.

FIG. 6B is an illustration of the tool of FIG. 6A assembling the clamp with the base plate secured to the blade of the fan, according to example embodiments.

FIG. 6C an illustration of a tool of FIG. 6A releasing the clamp onto the base plate secured to the blade of the fan, according to example embodiments.

FIG. 6D is an illustration of the clamp of FIG. 6A assembled onto the base plate secured to the blade of the fan, according to example embodiments.

FIG. 7 is a block diagram of a method of attaching an air purification filter to a device for attaching the air purification filter to a fan blade, according to example embodiments.

### DETAILED DESCRIPTION

An air purification filter attachment device, including a base and clamp, and methods of use thereof are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are within the scope of what is contemplated herein. In addition, the particular arrangements shown in the figures should not be viewed as limiting. It should be understood that other embodiments might include more or less of each element shown in a particular figure. Additionally, some of the illustrated elements can be combined or omitted. Yet further, an example embodiment can include elements that are not explicitly illustrated in the figures.

It would be advantageous to have an air purification device that combines innovative design, advanced filtration technology, and user-friendly functionality to effectively remove airborne contaminants while being seamlessly integrated with ceiling fans, which are likely already installed in many residential and commercial settings. By leveraging existing ceiling fan infrastructure, advantageously provided are passive, continuous sources of air filtration, especially when providing air improvement in areas where people spend most of their time (bedrooms, living rooms, and the like). Such air purification devices can offer economical and practical solutions for homeowners seeking to enhance air quality in specific zones of their homes as well as business owners seeking to target specific areas for better air quality in commercial settings. Such devices also can provide unique and valuable solutions for improving indoor air quality without being bulky and/or expensive.

Further, it would be advantageous to have a device capable of coupling an air purification device to the already existing infrastructure of a fan, such as to a blade of a ceiling fan. It would also be advantageous for the device to be easy to assemble and dissemble in order to periodically replace a used air purification device with a new one without having to use a ladder. For instance, an air purification filter can be attached to a fan blade by securing the air purification filter in a clamp, securing the clamp to a base plate, and coupling the combined clamp and base plate to the blade of the fan.

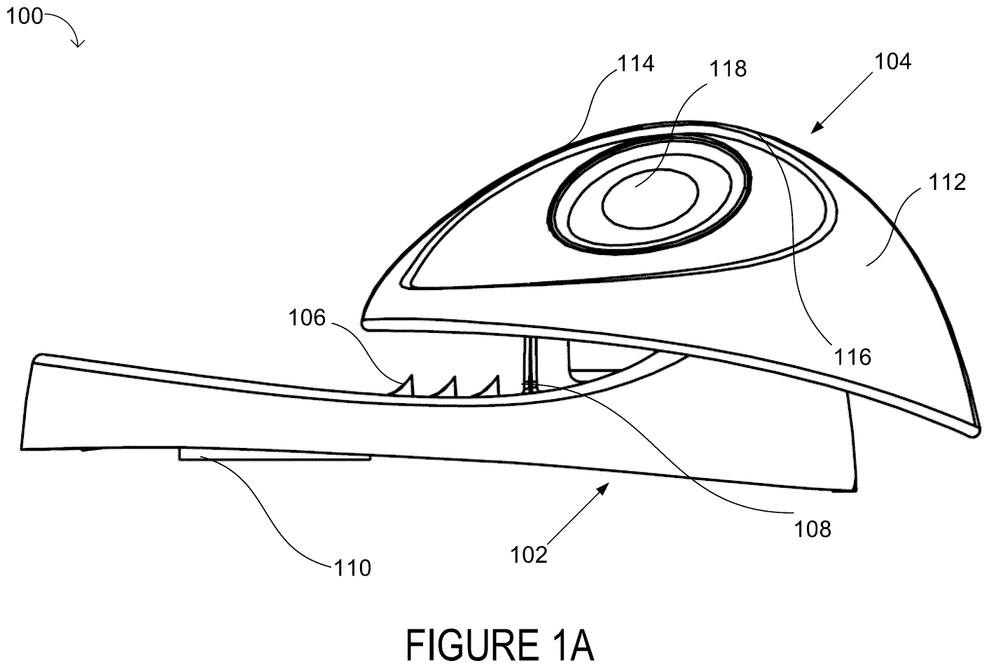

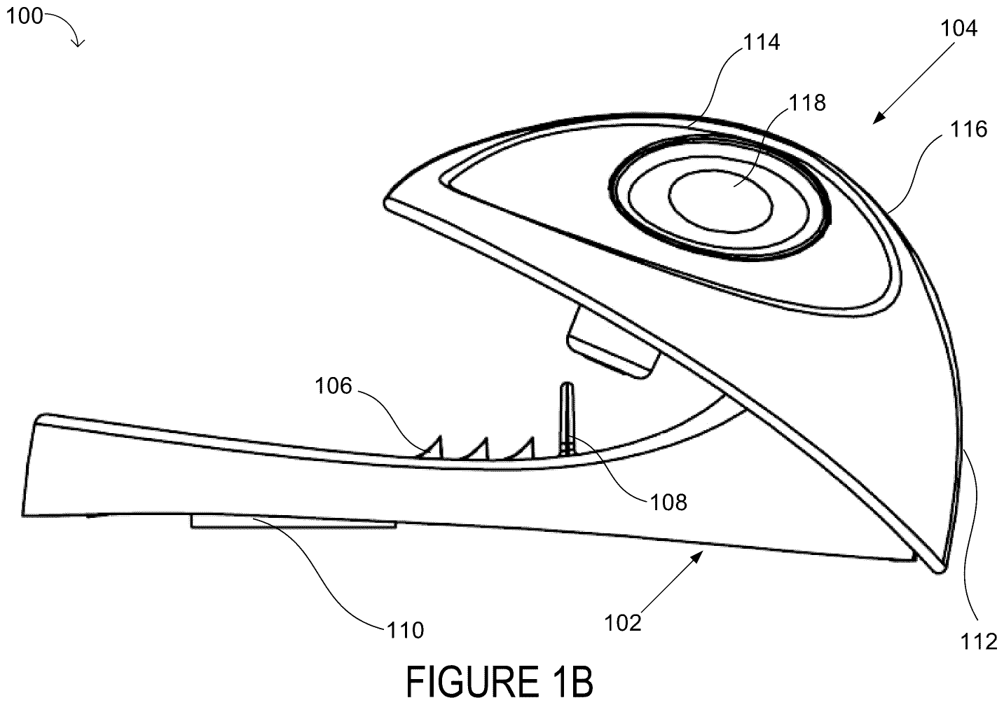

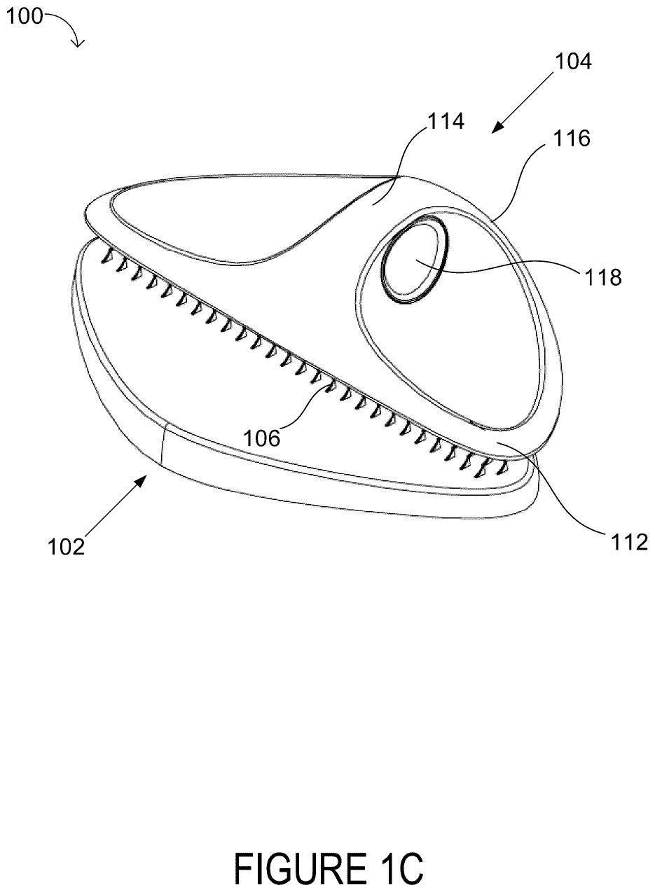

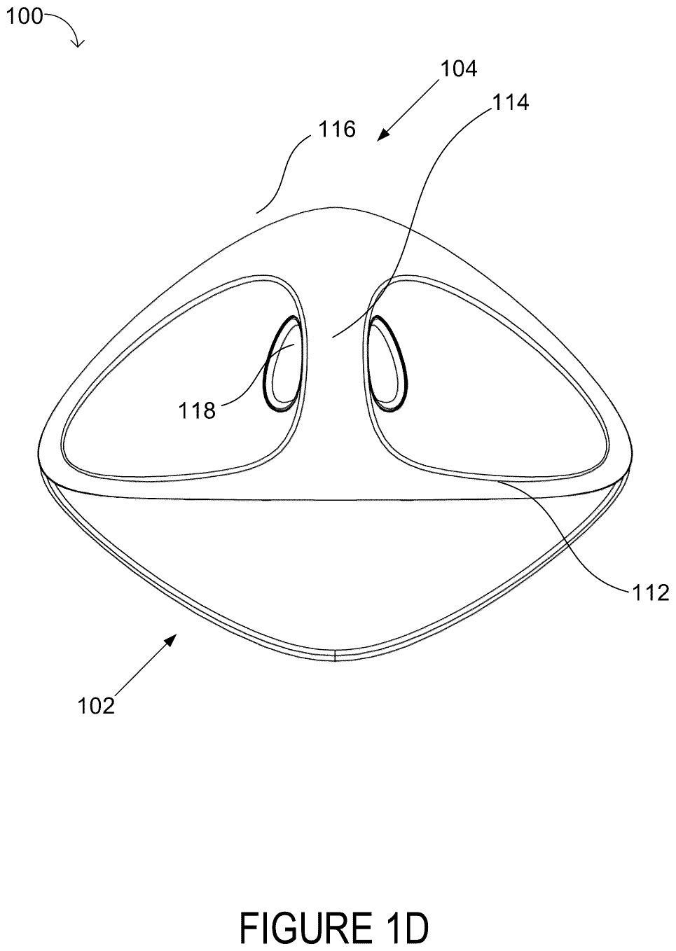

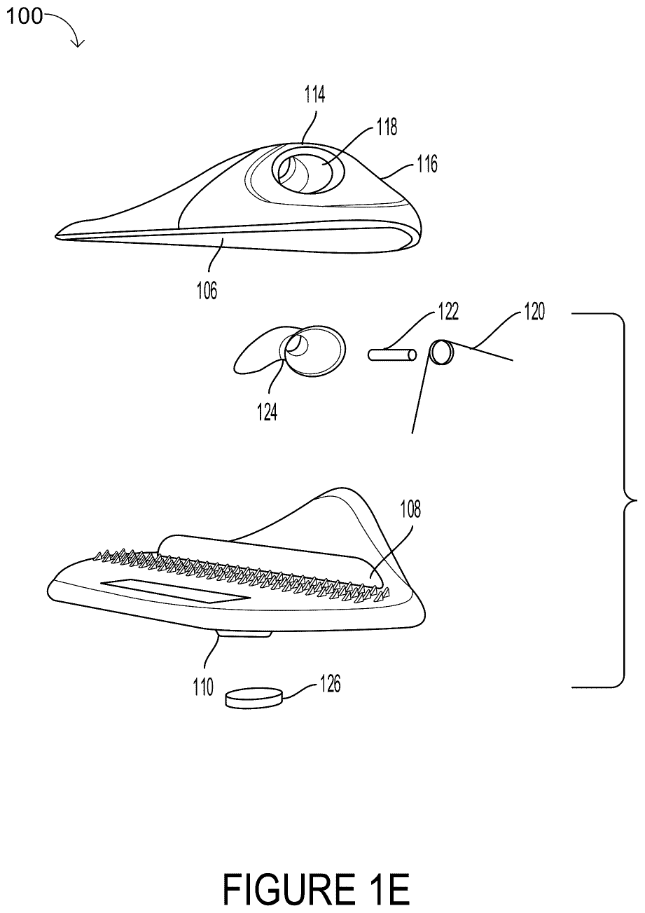

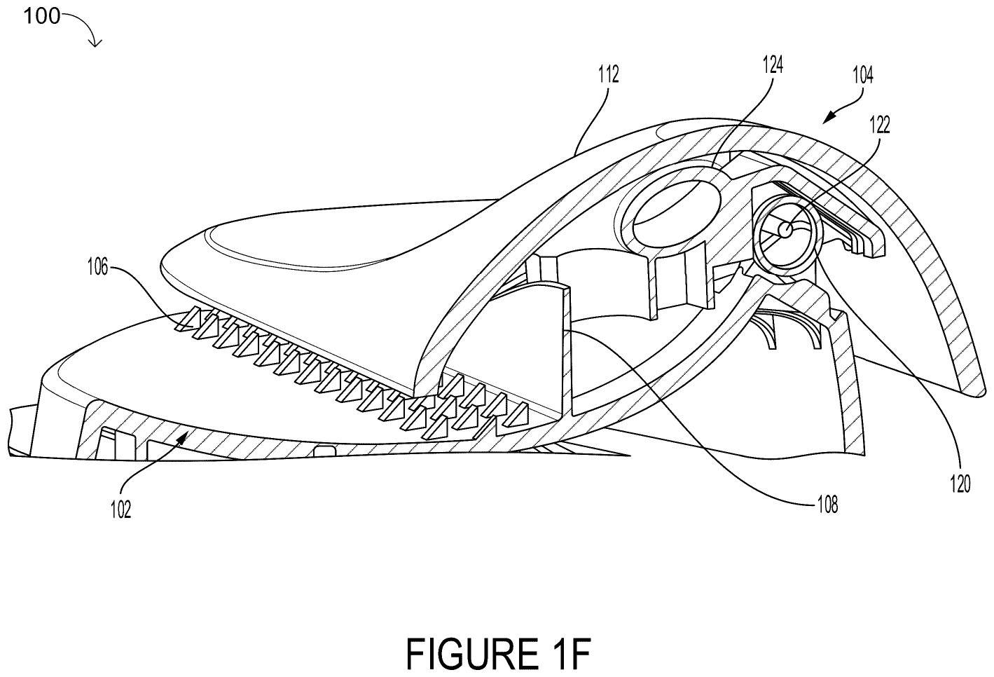

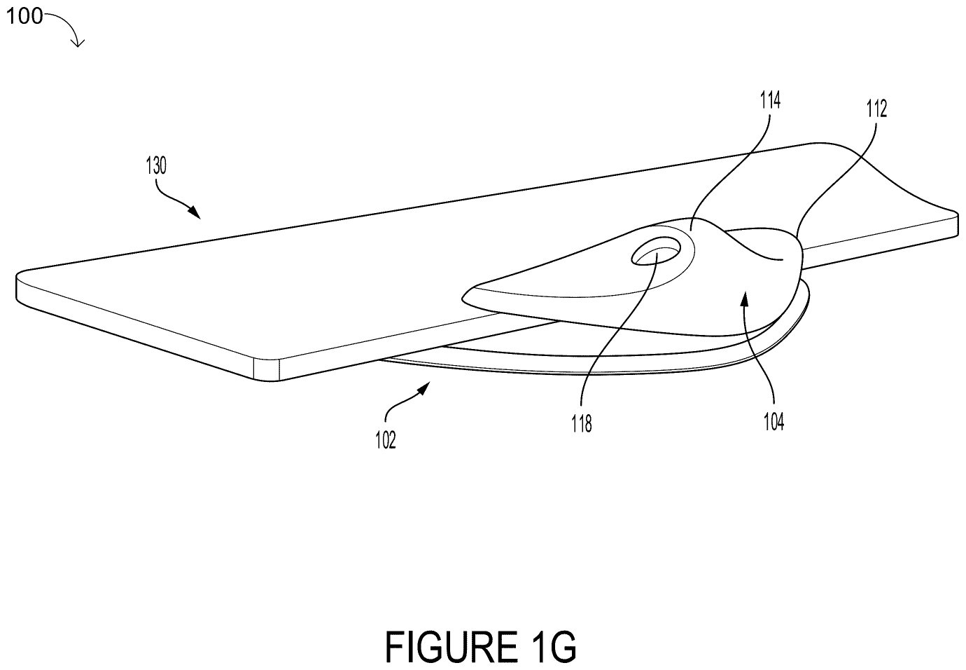

FIGS. 1A-1G depict a clamp 100 that can hold an air purification filter 130, according to example embodiments. In some embodiments, the clamp 100 for the air purification filter 130 is lightweight, durable, and strong wherein it can withstand persistent airflow generated by a fan to which it is attached. For instance, the clamp 100 needs to be lightweight enough so that it does not cause any bowing in a blade of the fan to which it is attached, whether it be a commercial or a residential ceiling fan. In addition, the clamp 100 having the air purification filter 130 needs to not cause imbalance to a moving fan due to excessive air resistance. However, the clamp 100 also needs to be durable and strong enough to retain the air purification filter 130 while the system is being subjected to standard wind force generated during rotation of the fan.

In some embodiments, the air purification filter 130 held by the clamp 100 can include a collection pad. The collection pad can be made of an impregnated polyester blend having a plurality of perforations through which air is configured to pass. In some embodiments, the impregnated polyester blend is a blended polyester material embedded with an air purifying matter. An impregnated material is generally any material that has been treated in order to accomplish certain material properties, such as lining, filling, imbuing, permeating, or saturating a porous substrate with an impregnating agent. For instance, an impregnated fabric material is any fabric material in which the spaces between yarns are completely filled with, or impregnated with, another material such as a polymer, adhesive, paint, or other substance. Further, for example, the collection pad can include a non-woven polyester fabric that has been impregnated with one or more advanced filtration materials. The one or more advanced filtration materials can include an activated coconut shell carbon, a zeolite (a microporous, three-dimensional crystalline solid of aluminum silicate), blends of the aforementioned, an alumina potassium, or another material capable of purifying the air. Further, in some embodiments, the air purification filter 130 can include any additional features, such as attaching mechanisms, apertures and/or die cuts for ease of retention, extrusions, or the like. For instance, the air purification filter 130 can include a die-cut through the material thickness of the air purification filter 130 in order for the air purification filter 130 to more easily bend upwards when exposed to airflow.

Referring to FIG. 1A, in some embodiments, the clamp 100 includes a stationary jaw 102 and a hinging jaw 104. In some embodiments, the stationary jaw 102 and the hinging jaw 104 are connected through a hinging mechanism wherein the hinging mechanism mechanically biases the hinging jaw 104 towards the stationary jaw 102. Further, in some embodiments, the stationary jaw 102 and the hinging jaw 104 are in opposable contact fixed by a hinging mechanism and having a force that resists separation of the hinging jaw 104 from the stationary jaw 102.

In an example embodiment, as illustrated in FIG. 1B, the hinging mechanism can be used to open and close the hinging jaw 104 relative to the stationary jaw 102 so that an air purification filter 130 can be held between the hinging jaw 104 and the stationary jaw 102 of the clamp 100.

The hinging mechanism can be any type of hinging component, such as a metal spring, like a torsional helical spring or leaf spring, in cooperation with a hinge pin. For instance, in some embodiments, the torsion spring can have a specific tensile strength, such as a torsion spring having a rating between 0.0111-0.0083 inch-pounds per degree, including 0.0097 inch-pounds per degree. In such embodiments, the torsion spring can be preloaded between the stationary jaw 102 and the hinging jaw 104 in a preloaded state. For example, when the torsion spring has a rating of 0.0097 inch-pounds per degree a force of 1.8 lbs will need to be applied in order to fully open the hinging jaw 104 from the stationary jaw 102.

In some embodiments, the hinging mechanism acts not only as a fulcrum but also serves to pivotally join together the hinging jaw 104 and the stationary jaw 102 of the clamp 100. For instance, as shown in FIGS. 1E-1F, the hinging mechanism can include torsional spring 120, securing member 122, and a fulcrum component 124 through which the hinging jaw 104 is connected to the stationary jaw 102. Accordingly, a user can apply upward pressure to the fulcrum component 124, which in turn rotates the securing member 122 and engages the torsional spring 120. In such embodiments, the pressure indirectly applied to the torsional spring 120 through the securing member 122 and the fulcrum component 124 permits the hinging jaw 104 to open from the stationary jaw 102 against the biasing force of the torsional spring 120. The air purification filter 130 then can be inserted between the hinging jaw 104 and the stationary jaw 102.

The stationary jaw 102 of the clamp 100, in some embodiments, can take on a variety of shapes, sizes, and thicknesses. Any suitable shape, size, and/or thickness of the stationary jaw 102 can be selected so that the stationary jaw can be removably attached onto a blade of a standard-sized ceiling fan. For instance, a shape, size, and thickness of the clamp 100 can be chosen so no portion of the clamp extends past a leading edge and/or a trailing edge of a blade of the fan.

The stationary jaw 102 of the clamp 100, in some embodiments, includes a variety of attachments and/or integral components. For example, as illustrated in FIG. 1B, the stationary jaw 102 includes a coupling member 106, a backstop 108, and/or a peg 110.

The coupling member 106 of the stationary jaw 102 can grip the air purification filter and, in some embodiments, can increase the coupling strength with which the air purification filter 130 is secured to the clamp 100. In such embodiments, the coupling member 106 adds an additional coupling component to the clamp 100 besides the force exerted by the hinging spring between the stationary jaw 102 and the hinging jaw 104.

In some embodiments, the coupling member 106 includes at least one prong. The prong can be a single spear extending from the stationary jaw 102. In an alternative embodiment, the at least one prong can be a plurality of teeth, as shown in FIGS. 1A-1C. In such embodiments where the coupling member 106 comprises a plurality of teeth, each tooth can be constructed to have the same size, each tooth can be angled toward the backstop 108, and each tooth can have a wider base and taper to a pointed end. For instance, each tooth can be 0.080 inches tall, 0.094 inches deep at its base, 0.004 inches thick at its tip, and 0.040 inches thick. Other dimensions are also possible. In other embodiments, each tooth of the plurality of teeth can comprise a needle shape.

In such embodiments described above when the coupling member 106 has a plurality of teeth, each tooth of the plurality of teeth may not be identical to the others. In some embodiments, the plurality of teeth can be organized in any fashion (i.e., in a single row, in a plurality of rows, in a grid pattern, randomly assembled, or the like). Other possibilities are also contemplated.

In the embodiments described above when the coupling member 106 has a plurality of teeth angled toward the backstop 108, each tooth can be shaped in order to ensure insertion of the air purification filter 130 is not impeded but extrusion of the air purification filter 130 is hampered because a tip of each tooth of the plurality of teeth retains a portion of the air purification filter 130. In such embodiments, the plurality of teeth can snag the fabric of the air purification filter 130 in order to retain the air purification filter 130. Consequently, the air purification filter 130 can be further secured within the clamp 100 when the clamp 100 is attached to a blade of a moving fan.

The coupling member 106, in other embodiments, includes an adhesive member that can stick to at least a portion of the air purification filter 130 when the air purification filter 130 is inserted into the clamp 100. The adhesive member can be any suitable material, such as a gel or other bonding material, that can removably-adhere to the inserted air purification filter 130.

In some embodiments, the coupling member 106 is integral to the stationary jaw 102, and is manufactured as one complete piece. In other embodiments, the coupling member 106 is manufactured entirely separate from the stationary jaw 102 and is attached to the stationary jaw 102 by a fastener, an adhesive, or the like. In such embodiments, the coupling member 106 can be made of the same or a dissimilar material to the stationary jaw 102.

The backstop 108 of the stationary jaw 102, in some embodiments, extends vertically from an interior surface of the stationary jaw 102. Therefore, the backstop 108 extends towards and interior surface of the hinging jaw 104 of the clamp 100. The backstop 108, in some embodiments, is designed to abut the air purification filter 130 when the air purification filter 130 is inserted between the stationary jaw 102 and the hinging jaw 104 of the clamp 100. In such configurations, the backstop 108 aligns the air purification filter 130 within the clamp 100. The air purification filter 130 then is inserted at the proper depth into the clamp 100 as well as ensuring that the air purification filter 130 is aligned in a perpendicular orientation to the backstop 108 so that the air purification filter 130 is at a predetermined orientation when the clamp 100 is attached to a blade of a fan.

In some embodiments, the backstop 108 can extend the full width or substantially the full width of the stationary jaw 102. In other embodiments, the backstop 108 can be shorter than the full width of the stationary jaw 102. Further, in still other embodiments, the backstop 108 can be split into multiple segments that are attached across a width of the stationary jaw 102.

In some embodiments, the backstop 108 is integral to the stationary jaw 102, and is manufactured as one complete piece. In other embodiments, the backstop 108 is manufactured entirely separate from the stationary jaw 102 and is attached to the stationary jaw 102 by a fastener, an adhesive, or the like. In such embodiments, the backstop 108 can be made of the same or a dissimilar material to the stationary jaw 102.

The peg 110, in some embodiments, can be inserted into a receiving slot in a base plate as described below. Peg 110 can have any suitable size, shape, and dimensionality as required by size, shape, and dimensionality of a corresponding receiving portion of the receiving unit for coupling. For example, as shown in FIGS. 1A-1B, the peg 110 can be substantially round in circumference, and the peg 110 can be received in an oblong, rounded receiving slot. The peg 110, in some embodiments, further includes at least one magnet 126. For instance, the at least one magnet 126 can have a grade between N35-N52, including grade N42. Further, in some embodiments, the magnet can have specific dimensionality, such as having a ⅝ inch diameter and a ⅛ inch thickness. In some embodiments, the peg 110 is integral to the stationary jaw 102. In other embodiments, the peg is completely separate and attachable to the stationary jaw 102.

In some embodiments of the stationary jaw 102, an interior surface of the stationary jaw 102 can be substantially flat. In other embodiments of the stationary jaw 102, as shown in FIGS. 1A-1B, at least a portion of the interior surface of the stationary jaw 102 is configured as a concave ramp that supports an air purification filter 130 while the fan is in circulation. In some embodiments, the concave ramp of the interior surface of the stationary jaw 102 has a downward-curved slope from an exterior edge of the stationary jaw 102 to the backstop 108. In other embodiments, the concave ramp of the interior surface of the stationary jaw 102 has a downward-curved slope from an exterior edge of the stationary jaw 102 to an edge of the coupling member 106. In other embodiments, the concave ramp of the interior surface of the stationary jaw 102 can continue past both the coupling member 106 and the backstop 108 to where the hinging jaw 104 and the stationary jaw 102 are attached. In such embodiments, the slope of the concave ramp can be variable across a length of the stationary jaw 102. With a sloped interior surface in this manner, an inserted air purification filter 130 will have an upward-tilting side nearest the exterior edge of the stationary jaw 102. Thus, in these configurations, air can easily be able to lift under the upward-tilting side of the air purification filter 130 when a fan blade is in motion, thus allowing for maximum air filtration. In some embodiments when the interior surface of the stationary jaw 102 comprises a concave ramp portion, the ramp can elevate the inserted air purification filter 130 by a particular degree, such as between 5 degrees and 25 degrees.

The hinging jaw 104 of the clamp 100, in some embodiments, includes a variety of features. For example, in some embodiments, the hinging jaw 104 includes an exterior surface 112 having an arched shape, a bridge 114 on a crest 116 of the exterior surface 112, and an eye 118 spanning a width of the bridge 114.

The exterior surface 112 of the clamp 100, in some embodiments, has an arched or a substantially-domed shape, is substantially parabolic in shape, or is a convex arc. In such embodiments, the exterior surface 112 is aerodynamic and ergonomic for use on a blade of a fan. Because of the aerodynamic nature of the exterior surface 112 in these embodiments, air can flow over the shape when the clamp 100 is in use on a blade of a fan. In other embodiments, other shapes and sizes of the exterior surface 112 are possible.

The bridge 114 on the crest 116 of the exterior surface 112 of the clamp 100, in some embodiments such as shown in FIG. 1C, is a relatively thin, soft-curved component that a user can easily grasp in their hand. As such, the bridge 114 on the crest 116 of the exterior surface 112, in some embodiments, acts as a grip portion or a handle for a user. In some embodiments, the bridge 114 can further be flanked by one or more hollow sockets on either side wherein a user can more easily utilize the bridge 114 as a handle. In such embodiments, the bridge 114 can be positioned on the crest 116 of the dome-shaped exterior surface 112 in a central position wherein the clamp 100 is balanced when a user picks it up by the bridge 114.

The eye 118 of the clamp 100, in some embodiments, is disposed between the bridge 114 and at least a portion of the exterior surface 112 of the hinging jaw 104. The eye 118 can be an aperture under the bridge 114 having any viable shape. In some embodiments, a rounded, oblong shape of the eye 118 is contemplated, such as is shown in FIGS. 1A-1G, but other shapes and sizes are also possible.

For instance, as shown in FIG. 1F, the eye 118 of the clamp 100 can have a substantially ovular shape. As such, the eye 118 can be ergonomic and functional in that a tool or a user's finger can be easily inserted into the eye 118. For instance, a user can pick up the clamp 100 by placing a palm on the bridge 114 and placing one or more fingers through the eye 118. Further, in some embodiments, the fulcrum component 124 can partially or fully line the eye 118. In such embodiments, the fulcrum component 124 can comprise a different material, such as a rubberized material, which has stronger grip properties than the material of the clamp 100.

Further, in some embodiments of the clamp 100, the stationary jaw 102 and the hinging jaw 104 can each be made out of a first material. The first material can be an injected molded plastic material, like an acrylic (PMMA), a nylon (PA), a polycarbonate (PC), a polyethylene (PE), a polyoxymethylene (POM), a polypropylene (PP), a polystyrene (PS), a thermoplastic elastomer (TPE), and a thermoplastic polyurethane (TPU). In such embodiments, the first material can be selected to withstand persistent airflow generated by the fan. In other embodiments, the stationary jaw 102 and the hinging jaw 104 can be made of dissimilar materials. Further, other components of the clamp 100 can also comprise dissimilar materials. Therefore, in some embodiments when the eye 118 can include a liner or the fulcrum component 124 on an inner surface of the eye 118, the interior of the eye 118 might have a second material, such as a carbon fiber or a silicone, that possesses a higher coefficient of friction than the first material of the hinging jaw 104.

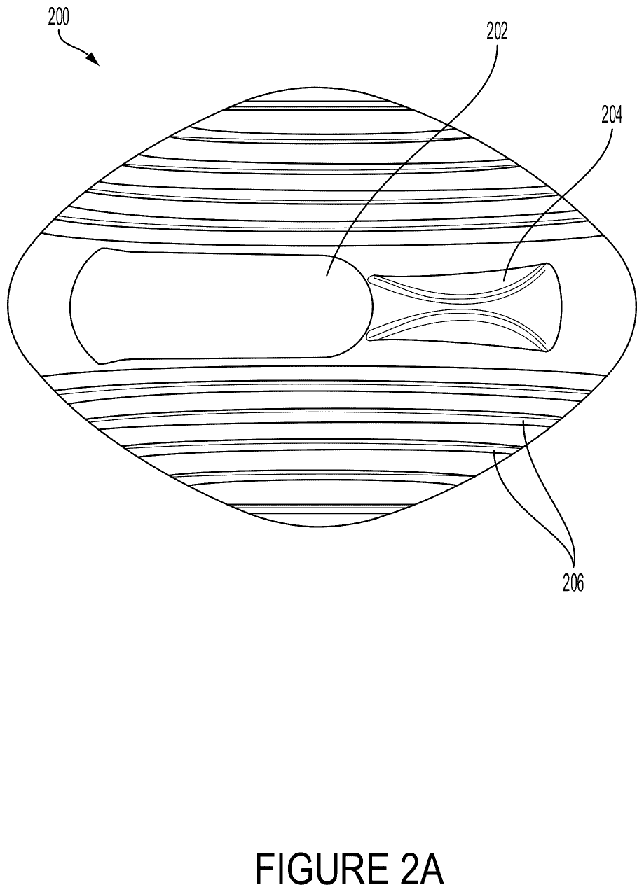

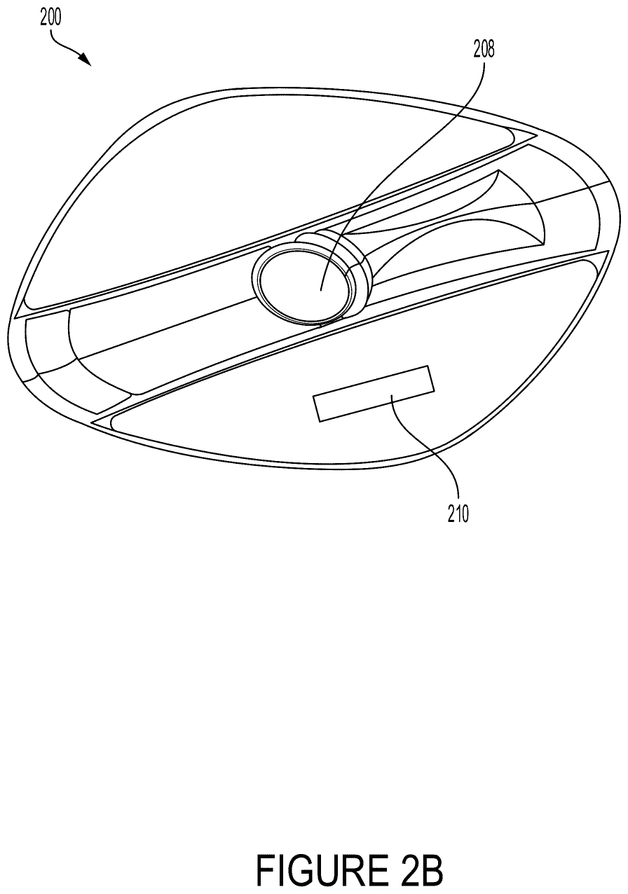

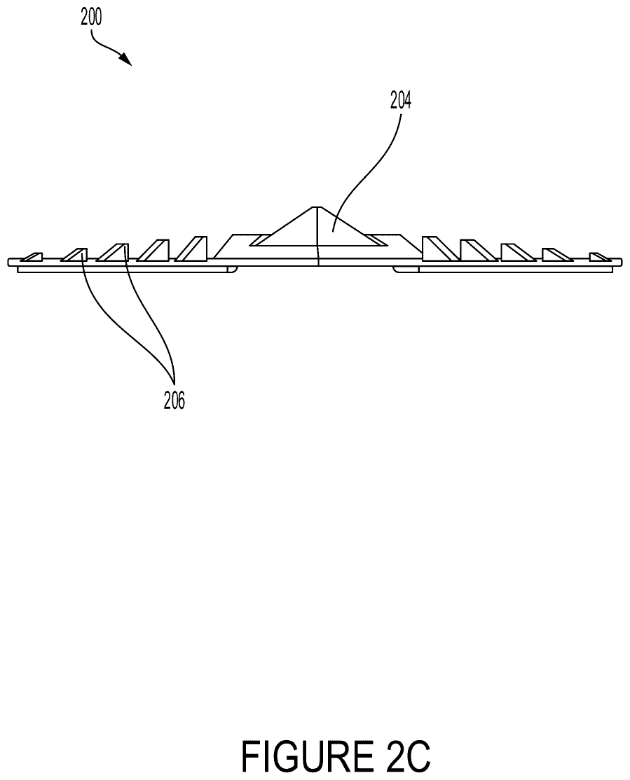

FIGS. 2A-2C depict a base plate 200. In some embodiments, the base plate 200 can be secured to a blade of a fan by a fastener, an adhesive, or another attaching mechanism, such as the adhesive 210 shown in FIG. 2B. In alternative embodiments, the fastener can extend over an entire surface of the bottom side of the base plate 200. Further, in some embodiments, the base plate 200 can receive a clamp, such as clamp 100, which in turn can secure an air purification filter 130. In such embodiments, the base plate 200 can be used to attach the clamp 100 (and therefore the air purification filter) to a blade of a fan. The base plate 200 can be any viable shape in order for the base plate 200 to be fully supported by a blade of a standard ceiling fan. In an example embodiment, the base can have a generally oblong or almond shape.

In some embodiments, the base plate 200 includes a receiving slot 202. In some embodiments of the receiving slot 202, the receiving slot 202 can include a 3-sided wall wherein the peg 110 of the clamp 100 has one point of entry into the receiving slot 202, and the 3-sided wall restricts movement of the clamp 100 in an undesired direction. In such embodiments, the walls of the receiving slot 202 can have any height capable of receiving the peg 110 of the clamp 100, such as between 0.010 inches and 0.059 inches tall, including 0.030 inches tall. In such embodiments, the receiving slot 202 can be indented into the base plate 200 by the height of the walls. Also, in such embodiments, the peg 110 of the clamp 100 can be guided from a proximal end (the end without a wall) of the receiving slot 202 to a distal end (the end with the middle portion of the 3-wall configuration) of the receiving slot 202.

Further, in some embodiments, the receiving slot 202 is oblong in shape and extends over a majority of a length of the base plate 200, such as is shown in FIG. 2A. In other embodiments, the receiving slot 202 can have any shape or size capable of retaining the peg 110 of the clamp 100.

In some embodiments, the base plate 200 also includes a stop 204. The stop 204 can be adjacent to the distal end of the receiving slot 202. Also, the stop 204 can abut a portion of the clamp 100 when the clamp 100 is secured to the base plate 200.

In some embodiments, the base plate 200 can be situated or capable of being situated on a blade of a fan, and the receiving slot 202 can be distally directed, where the open end of the receiving slot is assembled nearest a central joint of a fan and the deepest portion of the receiving slot 202 is distal from the central joint of the fan. In such embodiments, the clamp 100 would be restricted from movement towards the tip of the fan blade, the leading edge of the fan blade, and the trailing edge of the fan blade.

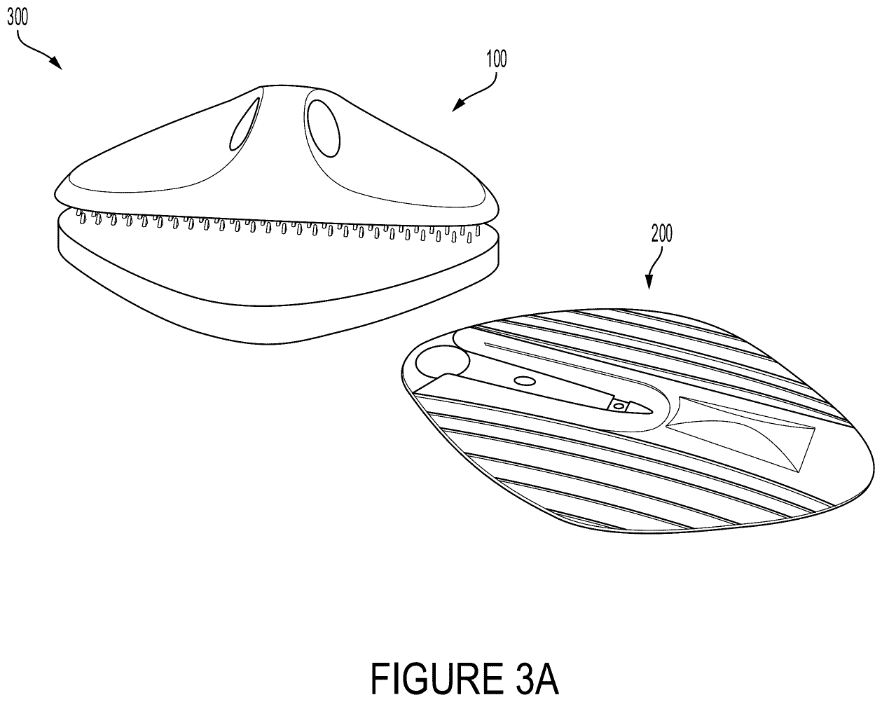

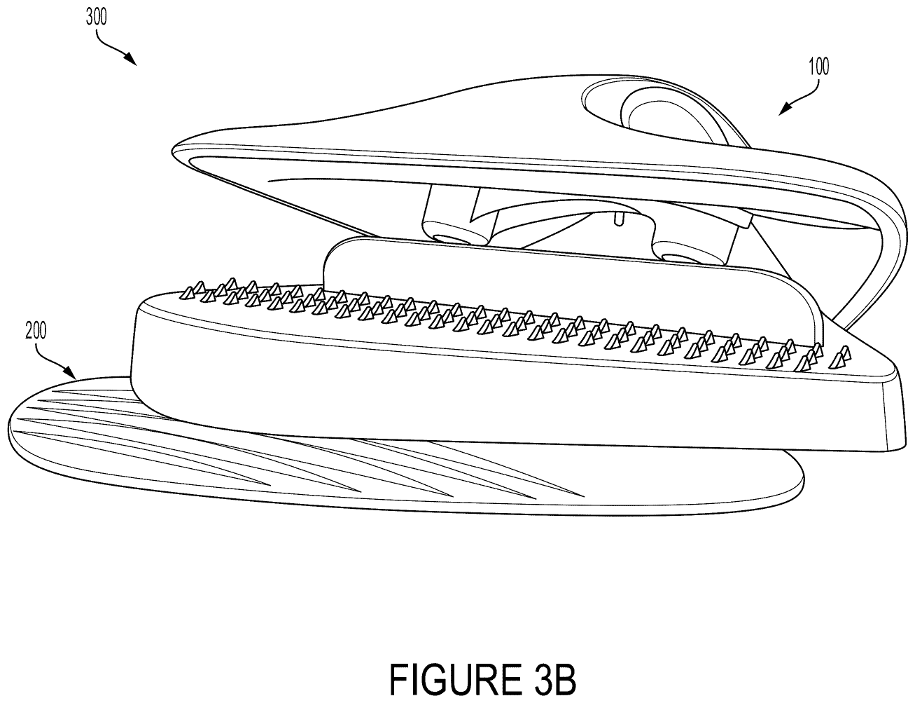

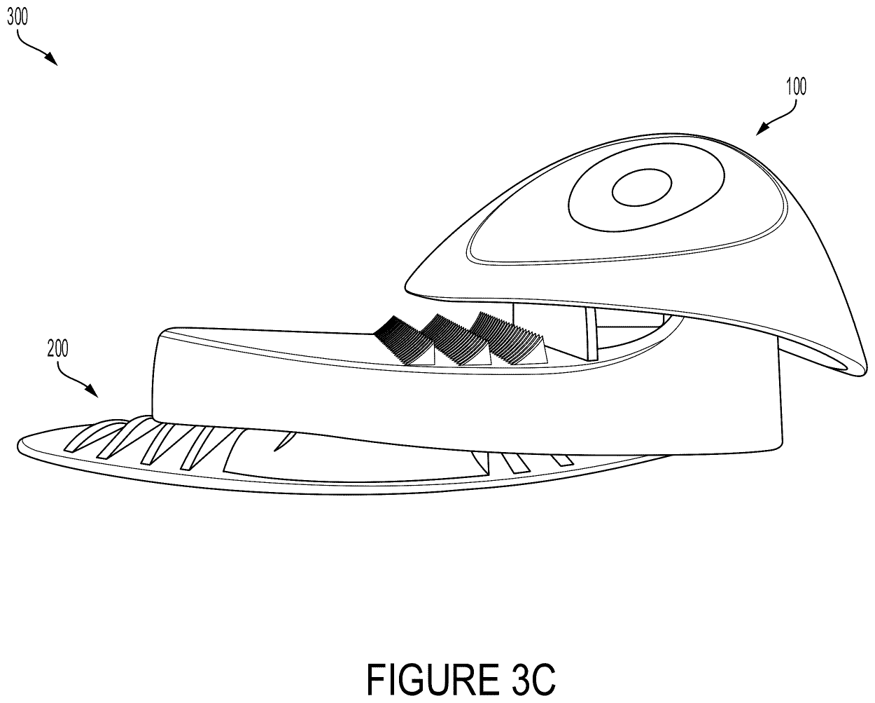

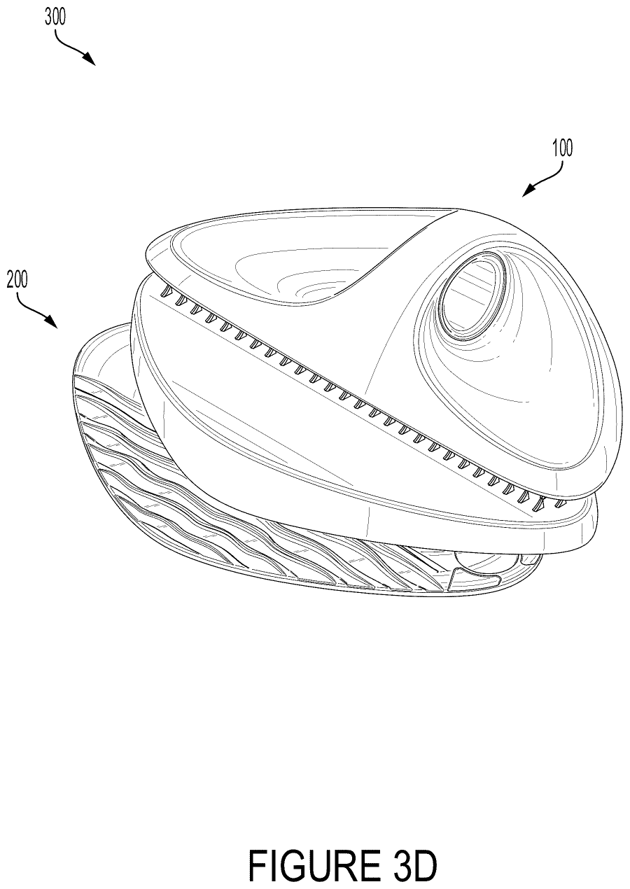

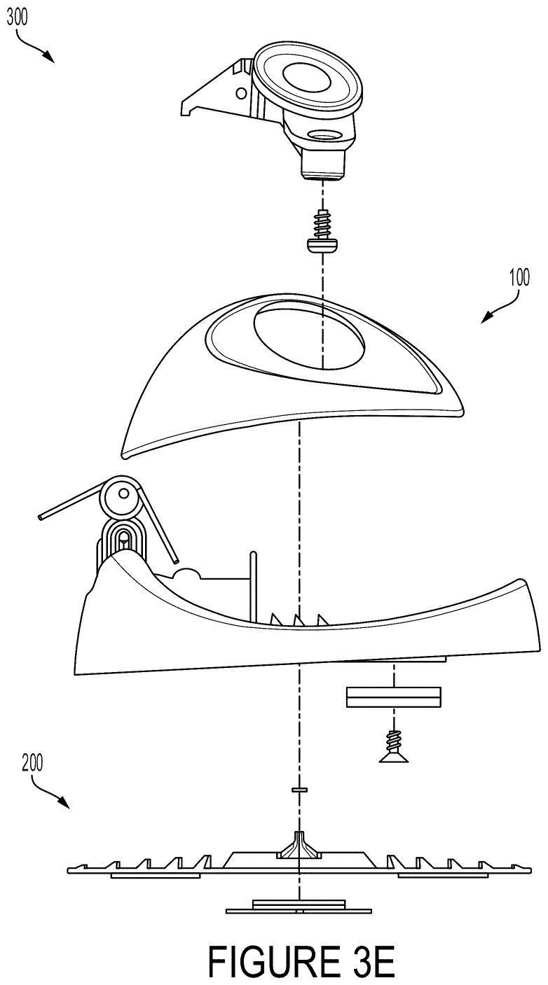

In some embodiments, the base plate 200 also includes a plurality of ridges 206. The plurality of ridges can run across a length of the base plate 200 and can be parallel with the receiving slot 202. In some embodiments, the plurality of ridges 206 are arranged in a pleated fashion, as shown in FIG. 2A. In some embodiments, the plurality of ridges 206 provide a contouring ability to the base plate 200, and the base plate 200 can be flexibly affixed to a curvature of the blade of a variety of fans. In some embodiments, the plurality of ridges 206 are arranged in a configuration that is non-parallel to the receiving slot 202, such as in a waved configuration (as best seen in FIG. 3D).

In some embodiments, the base plate 200 includes one or more magnets 208 on an underside of the base plate 200. The one or more magnets 208, in some embodiments, are disposed below a portion of the receiving slot 202 adjacent the stop 204 wherein, upon insertion of the peg 110 of the clamp 100, the at least one magnet 126 in the peg 110 is secured to the one or more magnets 208 to further secure the clamp 100 to the base plate 200. For instance, each of the one or more magnets 208 can have a grade between N35-N52, including grade N42. Further, in some embodiments, the one or more magnets 208 can be a single magnet, and the magnet can have specific dimensionality, such as having a ⅝ inch diameter and a 1/16 inch thickness. In such embodiments, the one or more magnets 208 in the base plate can be polarized through their thickness and attachable to the at least one magnet 126 in the peg 110 where a force to vertically pull the components apart is 2.2 lbs., whereas the force to slide the components apart is 1.2 lbs. Accordingly, it is easier to slide the components (i.e., the clamp 100 and the base plate 200) in relation to one another than to pull them apart directly.

FIGS. 3A-3E show a device 300 that combines the clamp 100 and the base plate 200. FIG. 3A shows the clamp 100 before coupled with the base plate 200. FIG. 3B shows the peg 110 of the clamp 100 being inserted into the receiving slot 202 of the base plate 200. FIG. 3C shows the clamp 100 being coupled with the base plate 200. The device 300 can receive an air purification filter 130 and effectively combine to couple it to a blade of a fan. FIG. 3D shows the base plate 200 having a plurality of ridges in a waved configuration, as an example variant of the plurality of ridges of the base plate 200. FIG. 3E shows the clamp 100 above the base plate 200, which also includes the peg 110 of the clamp 100 aligning with the receiving slot 202 of the base plate 200.

In some embodiments, the clamp 100 can be fit into the base plate 200 where the underside of the clamp 100 can be substantially parallel with the base plate 200. In other embodiments, the clamp 100 can be inserted into the base plate 200 at a lead-in angle, such as a lead-in angle of 5 degrees to 10 degrees, including 7.5 degrees. Further, in such embodiments, the plurality of ridges 206 of the base plate 200 can be increasing in size at a rate consistent with the lead-in angle of the underside of the clamp 100 in order to support the clamp 100.

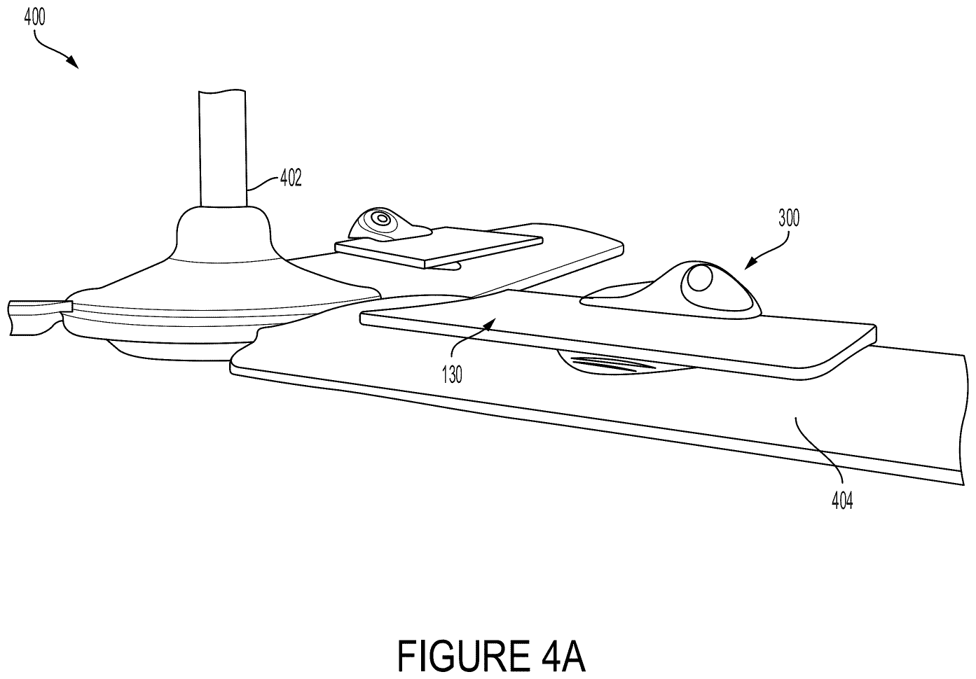

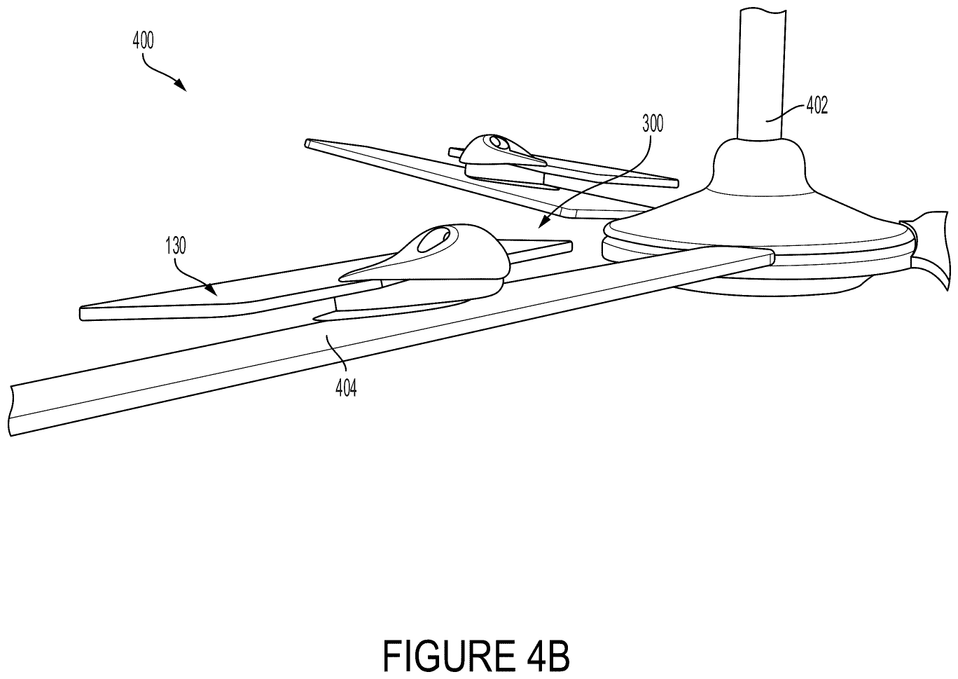

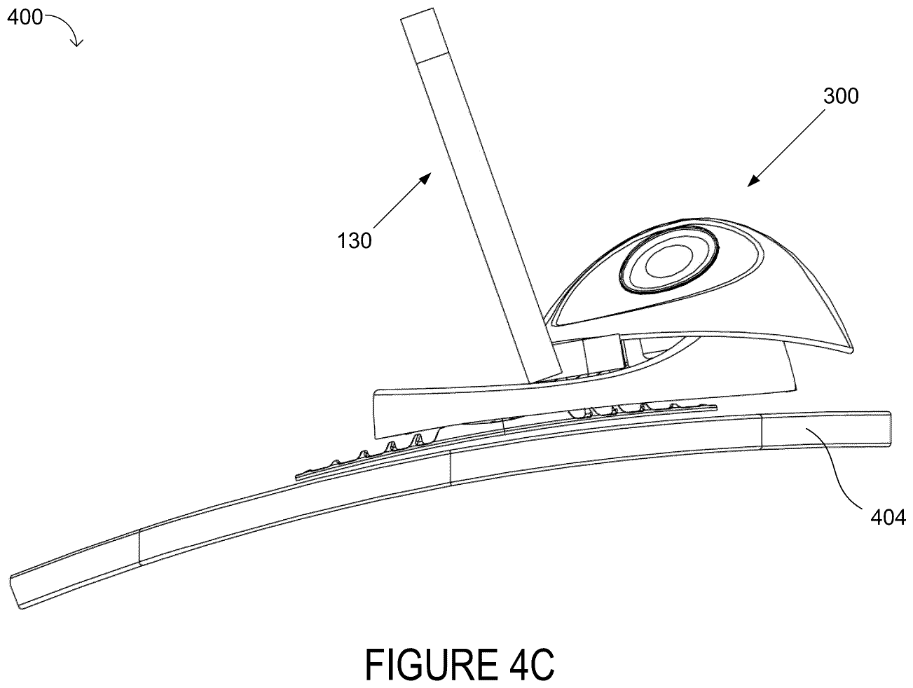

FIGS. 4A-4C show a fan 400 having a post 402 being a central joint of the fan 400. The fan 400 also includes a plurality of fan blades, including fan blade 404. The device 300, which is made up of the base plate 200 coupled with the clamp 100 and which in turn is securing the air purification filter 130, is mounted to the fan blade 404. In some embodiments, a device 300 is mounted on each fan blade of the plurality of fan blades of the fan 400. In other embodiments, a device 300 is mounted on fewer than all of the plurality of fan blades of the fan 400. In other embodiments still, more than one device 300 is mounted on each fan blade of the plurality of fan blades of the fan 400.

In some embodiments, the device 300 can be mounted interchangeably. That is, the direction in which the device is mounted can change. The peg 110 of the clamp 100 can be inserted into the receiving slot 202 of the base plate 200 facing a leading edge of the fan blade no matter the direction of rotation of the fan 400. Alternatively, the peg 110 of the clamp 100 can be inserted into the receiving slot 202 of the base plate 200 facing a trailing edge of the fan blade. As such, a free end of the filter 130 can be picked up by the air when the fan 400 is in motion. Because of this, such as is shown in FIG. 4C, the free portion from the clamp 100 of the air purification filter 130 is lifted when the fan 400 is in motion, thus maximizing the surface area of the air purification filter 130 that can filter particles in the air in the environment of the fan 400.

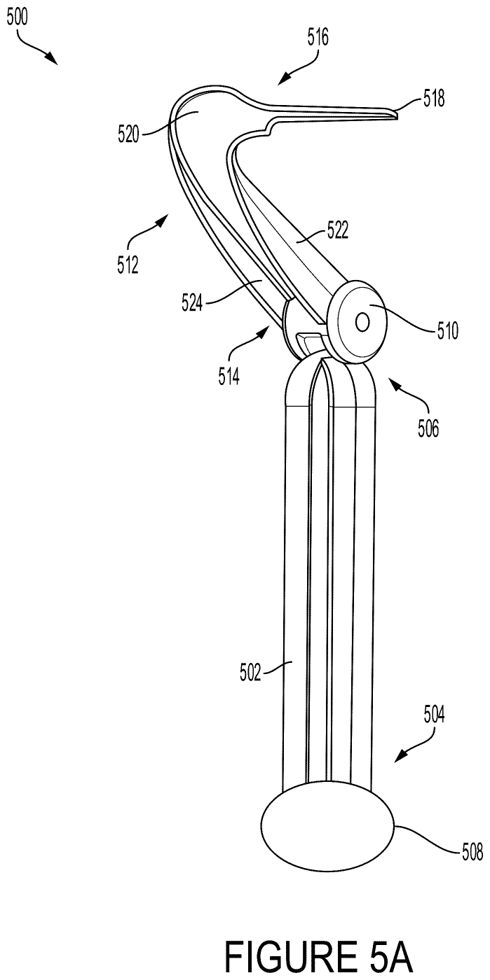

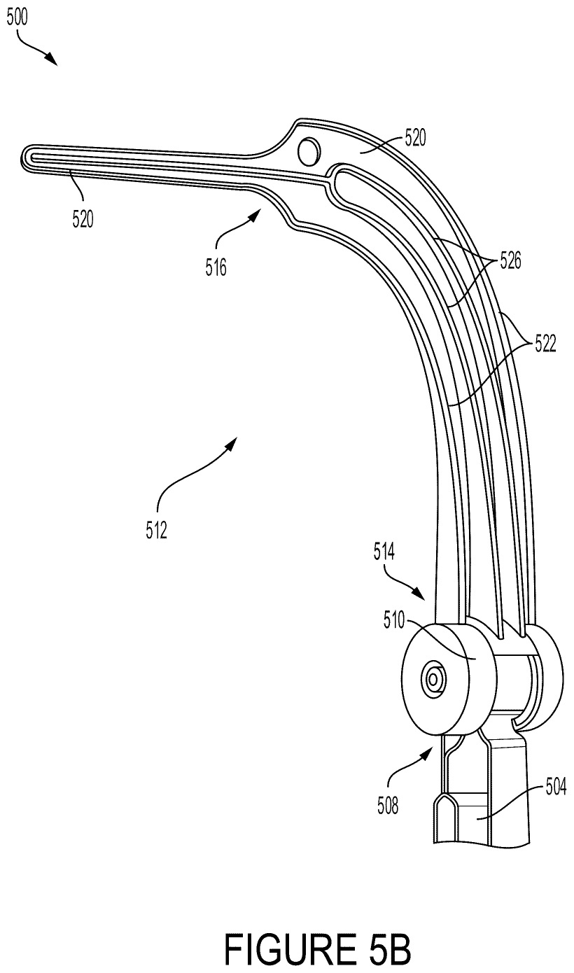

FIGS. 5A-5B depict a tool 500 for attaching the clamp 100 to the base plate 200 that is affixed to the fan blade 404 of the fan 400. The tool 500 includes an elongated arm 502. In some embodiments, the elongated arm 502 is telescoping. In such embodiments, the elongated arm 502 can be extended so that the tool 500 can easily install or remove the device 300 on the fan blade 404 of the fan 400. Additionally, the tool 500 can also be compacted for ease of storage when not in use. Further, in some embodiments, the elongated arm 502 includes a lower, first end 504 and an upper, second end 506. In some embodiments, a hand grip 508 or other gripping device is coupled to the first end 504 of the tool 500 for ease of use of the tool 500 by a user. Additionally, in some embodiments, a pivoting assembly 510 is coupled to a second end 506 of the elongated arm 502.

In some embodiments of the tool 500, a curved beak 512 is coupled to the pivoting assembly 510 on the second end 506 of the elongated arm 502. In some embodiments, the curved beak 512 includes a proximal portion 514 coupled to the pivoting assembly 510 and a distal portion 516 that comprises a pointed tip 518 configured to be inserted into the eye 118 of the clamp 100. As such, the curved beak 512 can be bent in relation to the elongated arm 502 through the pivoting assembly 510 in order to achieve the appropriate angle of assembly/disassembly of the clamp 100 from the base plate 200 on the fan blade 404 of the fan 400.

Further, in some embodiments, the curved beak 512 includes a base platform 520, one or more anterior ridges 522 that slope downwards from the proximal portion 514 of the curved beak 512 towards the distal portion 516 of the curved beak 512, and one or more posterior ridges 524 that slope downwards from the proximal portion 514 of the curved beak 512 towards the distal portion 516 of the curved beak 512. Further, in some embodiments, the curved beak 512 includes a plurality of additional structural ridges 526 on one or both of the anterior and posterior sides of the base platform 520 of the curved beak 512. In such embodiments, the one or more anterior ridges, the one or more posterior ridges, and/or the plurality of additional structural ridges on the base platform 520 of the curved beak 512 provide a tapered thickness to the curved beak 512 where insertion of the curved beak 512 into the eye 118 of the clamp 100 is eased in until the thickness of the curved beak 512 makes a secure-enough contact with an interior of the eye 118 of the clamp 100 to establish control of the clamp 100 by the tool 500. In addition, the one or more anterior ridges, the one or more posterior ridges, and/or the plurality of additional structural ridges on the base platform 520 of the curved beak 512 provides support for the structure of the curved beak 512 as well as creating friction between the curved beak 512 and the eye 118 of the clamp 100.

In some embodiments of the tool 500, the curved beak 512 can be insertable into an already-existing telescoping pole through its pivoting assembly 510.

In some embodiments, the tool 500 can further include a mirror structure. The mirror is capable of visualizing the top portion of the fan blade 404 of the fan 400. This feature permits aligning the clamp 100 with base plate 200 using the tool 500 to be more easily accomplished.

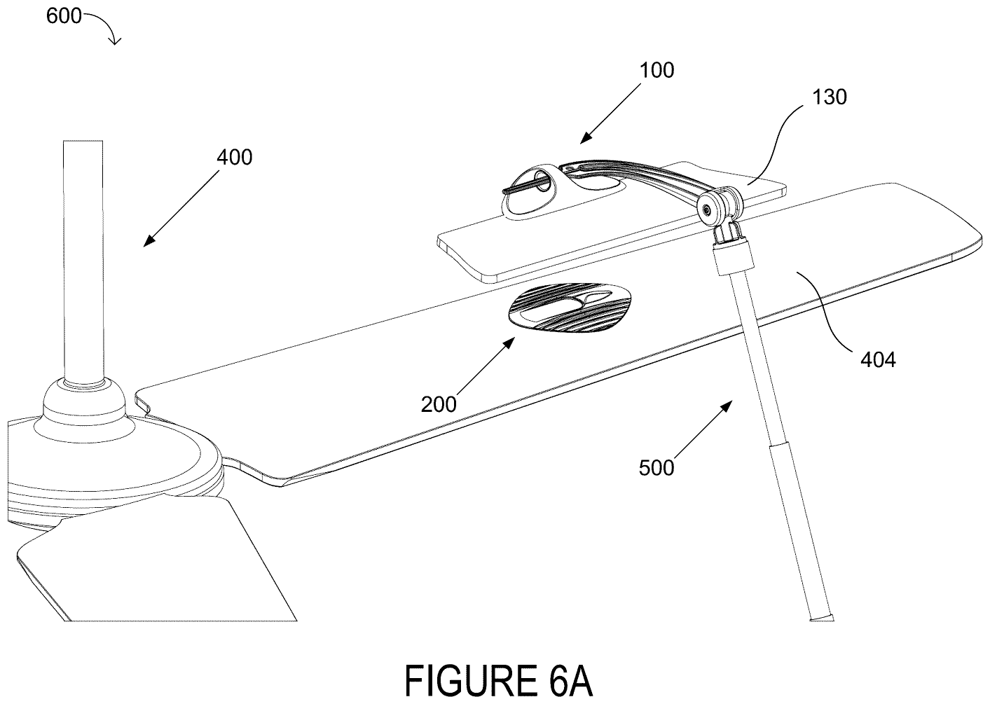

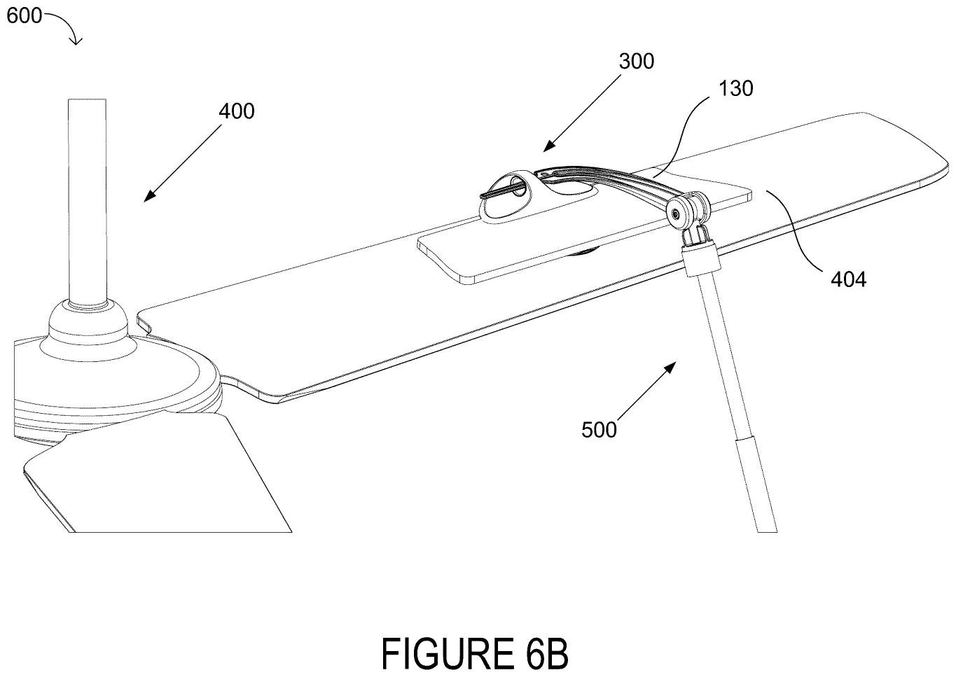

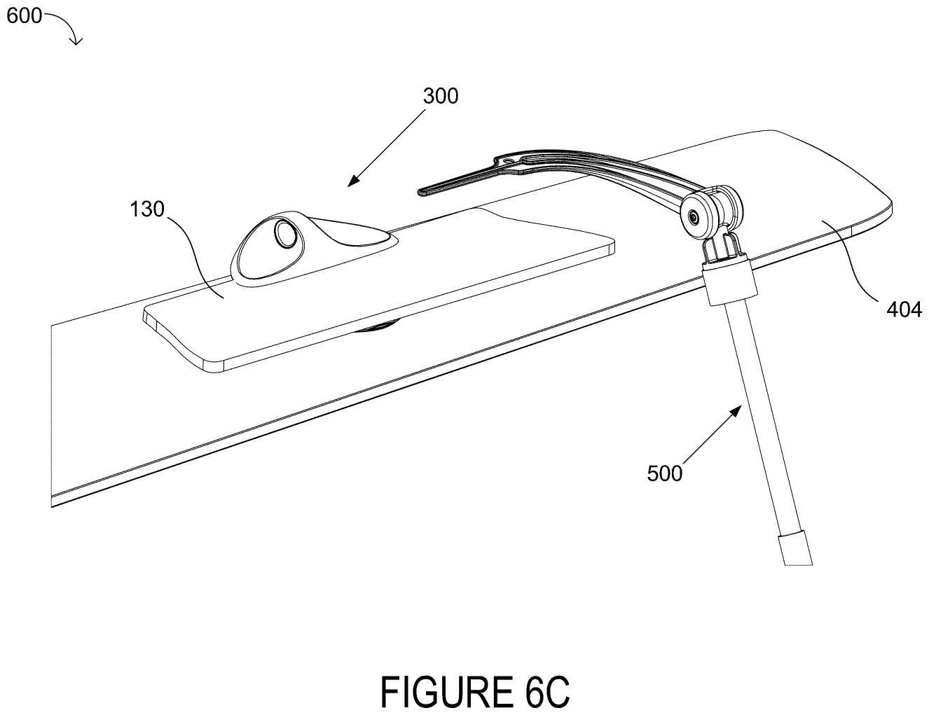

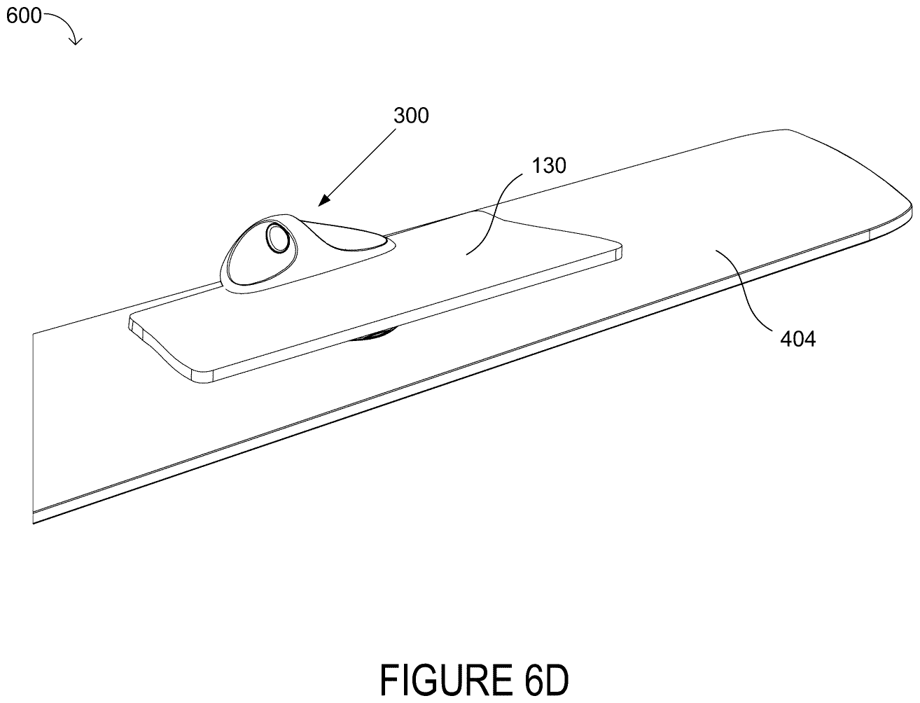

FIGS. 6A-6D depict a system 600 having the tool 500 assist in coupling the clamp 100 securing the air purification filter 130 to the base plate 200 that is already affixed to the fan blade 404 to the fan 400. In some embodiments, the tool 500 can be inserted into the eye 118 of the clamp 100 and controllably raised toward the base plate 200 affixed to the fan blade 404 of the fan 400, as shown in FIG. 6A. Then, as shown in FIG. 6B, the tool 500 can be used to align the clamp 100 with the base plate 200 and then guide the clamp 100 along the receiving slot 202 of the base plate 202 until the clamp 100 and the base plate 200 are securely coupled to each other. Upon proper coupling of the clamp 100 and the base plate 200, the tool 500 can then be removed from the eye 118 of the clamp 100, as is shown in FIG. 6C. With the removal of the tool 500, the clamp 100 has successfully secured the air purification filter 130 to the fan blade 404 through the base plate 200.

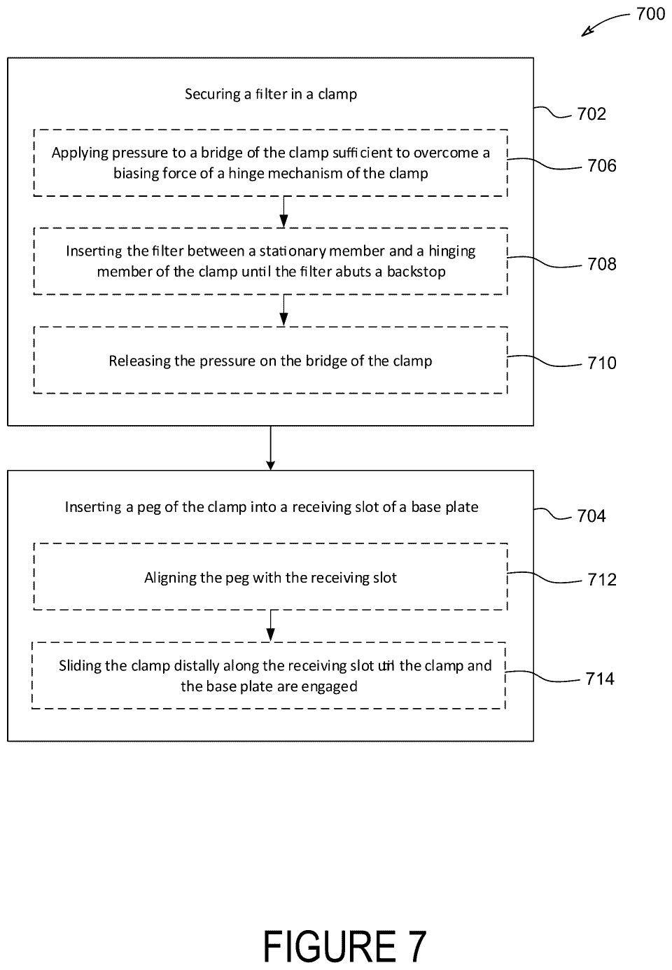

FIG. 7 is a block diagram of a method 700 of attaching an air purification filter to a device for attaching the air purification filter to a fan blade. As shown in FIG. 7, the method 700 includes one or more operations, functions, or actions as illustrated by blocks 702-714. Any additional blocks can be performed in parallel, and/or in a different order than those described herein. Also, the various blocks can be combined into fewer blocks, divided into additional blocks, and/or removed based upon the desired implementation.

At block 702, the method 700 includes securing the air purification filter in a clamp, such as the air purification filter 130 and the clamp 100. In some embodiments securing the air purification filter in a clamp includes applying pressure to a bridge of the clamp sufficient to overcome a biasing force of a hinging mechanism of the clamp, such as in block 706, inserting the air purification filter between a stationary member and a hinging member of the clamp until the air purification filter abuts a backstop, such as in block 708, and releasing the pressure on the bridge of the clamp, such as in block 710.

In some embodiments of performing the method step in block 702 of the method 700, applying pressure to the bridge of the clamp sufficient to overcome the biasing force of the hinging mechanism of the clamp includes a user squeezing a user-interfacing portion of the hinging mechanism with enough pressure to overcome the biasing force of the hinging mechanism. For instance, when the hinging mechanism includes a torsion spring rated 0.0097 inch-pounds per degree that is preloaded into the assembly of the clamp, it would take an outside force of 1.8 lbs. to fully open the hinging jaw from the stationary jaw of the clamp.

At block 704, the method 700 includes inserting a peg of the clamp into a receiving slot of a base plate, such as the peg 110 of the clamp 100 and the receiving slot 202 of the base plate 200. In some embodiments, inserting a peg of the clamp into a receiving slot of a base plate includes aligning the peg with the receiving slot, such as in block 712, and sliding the clamp distally along the receiving slot until the clamp and the base plate are engaged, such as in block 714.

In some embodiments of the method 700, sliding the clamp distally along the receiving slot until the clamp and the base plate are engaged includes engaging a base magnet with a clamp magnet wherein the base magnet and the clamp magnet are magnetized to each other. In such embodiments, the base magnet is proximate to at least a portion of the receiving slot in the base plate and the clamp magnet is in the peg of the clamp.

In some embodiments of the method 700, sliding the clamp distally along the receiving slot until the clamp and the base plate are engaged includes sliding the clamp distally along the receiving slot until a peg of the clamp abuts a stop that is adjacent a distally directed end of the receiving slot.

In some embodiments, the method 700 can be used for attaching the air purification device to a blade of a fan for the first time. In other embodiments, the method 700 can include replacing a used air purification filter with a new one.

When applying the air purification device to a blade of a fan for the first time, a user can align a base plate 200 with the blade of the fan wherein the entirety of the footprint of the base plate 200 is supported by the blade of the fan. In such embodiments, the method 700 can include coupling the base plate 200 to the blade of the fan wherein the receiving slot 202 is positioned where movement of the clamp 100 is mechanically restricted by the three-wall shape towards the blade tip, the leading edge of the fan blade, and the receiving edge of the fan blade. In such embodiments, the clamp 100 can then be coupled with the base plate 200 by positioning the clamp 100 further towards a central post of the fan and progressively sliding the clamp towards a tip of the fan blade. In doing so, the peg of the clamp 100 can be guided along the side walls of the receiving slot of the base plate 200 until the peg interacts with the middle portion of the three-wall configuration, the clamp 100 abuts the backstop of the base plate 200, and/or the one or more magnets in the peg of the clamp become removably connected with the one or more magnets in the base plate 200. Coupling the clamp 100 with the base plate 200 can be done manually by having a user directly handle the clamp 100 with their hand. In other embodiments, a tool can be used to couple the clamp 100 with the base plate 200. In such embodiments, a user may not need to use a ladder or other elevating device in order to reach the top of the blade of the fan to perform this coupling.

When replacing the air purification filter in the air purification device, a user can either use a hand or a tool to pull the clamp 100 away from the stop on the base plate 200 until the magnets are decoupled from each other and/or the peg of the clamp 100 is fully removed from the open end of the receiving slot of the base plate 200. The clamp 100 can then be lowered to the user, the user can apply pressure to the clamp 100 to free the used air purification filter from between the components of the clamp 100, and the user can place a new air purification filter into the clamp 100. The user can then repeat the steps described above to raise the clamp 100 back to the fan blade and couple the clamp 100 with the already-mounted base plate 200 on the blade of the fan.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A clamp comprising:
a stationary jaw, wherein the stationary jaw comprises:
a coupling member,
a backstop, wherein the backstop extends vertically from an interior surface of the stationary jaw, and
a peg; and
a hinging jaw, wherein the hinging jaw comprises:
an exterior surface, wherein the exterior surface comprises an arched shape,
a bridge on the exterior surface of the hinging jaw, wherein the bridge is on a crest of the exterior surface, and
an eye spanning a width of the bridge, wherein the eye is disposed between the bridge and at least a portion of the exterior surface of the hinging jaw, wherein the stationary jaw and the hinging jaw are in opposable contact fixed by a hinging mechanism and having a force that resists separation of the hinging jaw from the stationary jaw.

2. The clamp of claim 1, wherein the coupling member comprises at least one prong.

3. The clamp of claim 2, wherein the at least one prong comprises a plurality of teeth.

4. The clamp of claim 3, wherein the plurality of teeth are angled toward the backstop.

5. The clamp of claim 1, wherein the coupling member comprises an adhesive member.

6. The clamp of claim 1, wherein the peg comprises at least one magnet.

7. The clamp of claim 1, wherein at least a portion of the interior surface of the stationary jaw comprises a concave ramp.

8. The clamp of claim 7, wherein the concave ramp comprises a downward-curved slope from an exterior edge of the stationary jaw to the backstop.

9. The clamp of claim 1, wherein the exterior surface of the hinging jaw comprises a first material, and wherein the first material is at least one of an acrylic (PMMA), a nylon (PA), a polycarbonate (PC), a polyethylene (PE), a polyoxymethylene (POM), a polypropylene (PP), a polystyrene (PS), a thermoplastic elastomer (TPE), and a thermoplastic polyurethane (TPU).

10. The clamp of claim 9, wherein the eye comprises a liner, and wherein the liner is a second material having a higher coefficient of friction than the first material of the hinging jaw.

11. A device comprising:
a base plate having a length and comprising a receiving slot, wherein the receiving slot is distally directed; and
a clamp comprising:
a stationary jaw, wherein the stationary jaw comprises:
a coupling member,
a backstop, wherein the backstop extends vertically from an interior surface of the stationary jaw, and
a peg, wherein the peg is configured to be inserted into the receiving slot; and
a hinging jaw, wherein the hinging jaw comprises:
an exterior surface, wherein the exterior surface comprises an arched shape,
a bridge on the exterior surface of the hinging jaw, wherein the bridge is on a crest of the exterior surface, and
an eye spanning a width of the bridge, wherein the eye is disposed between the bridge and at least a portion of the exterior surface of the hinging jaw, wherein the stationary jaw and the hinging jaw are in opposable contact fixed by a hinging mechanism and having a force that resists separation of the hinging jaw from the stationary jaw.

12. The device of claim 11, wherein the receiving slot is oblong in shape, and wherein the receiving slot extends across a majority of the length of the base plate.

13. The device of claim 11, wherein the base plate further comprises a stop, and wherein the stop is adjacent a distally directed end of the receiving slot.

14. The device of claim 11, wherein the base plate further comprises a plurality of ridges.

15. The device of claim 14, wherein the plurality of ridges are arranged in a pleated fashion.

16. The device of claim 11, wherein the base plate further comprises a base magnet proximate to at least a portion of the receiving slot, and wherein the clamp further comprises a clamp magnet in the peg wherein the base magnet and the clamp magnet are magnetized to each other when the peg of the clamp is inserted into the receiving slot of the base plate.

17. The device of claim 11, wherein the peg is reversibly insertable into the receiving slot of the base plate.

18. A method of attaching an air purification filter to a device for attaching the air purification filter to a fan blade, the method comprising:
securing an air purification filter in a clamp, wherein securing the air purification filter in the clamp comprises:
applying pressure to a bridge of the clamp sufficient to overcome a biasing force of a hinging mechanism of the clamp;
inserting the air purification filter between a stationary member and a hinging member of the clamp until the air purification filter abuts a backstop; and
releasing the pressure on the bridge of the clamp;
inserting a peg of the clamp into a receiving slot of a base plate, wherein inserting the peg of the clamp into the receiving slot of the base plate comprises:
aligning the peg with the receiving slot; and
sliding the clamp distally along the receiving slot until the clamp and the base plate are engaged.

19. The method of claim 18, wherein sliding the clamp distally along the receiving slot until the clamp and the base plate are engaged comprises:
engaging a base magnet with a clamp magnet, wherein the base magnet and the clamp magnet are magnetized to each other, wherein the base magnet is proximate to at least a portion of the receiving slot in the base plate, and wherein the clamp magnet is in the peg of the clamp.

20. The method of claim 18, wherein sliding the clamp distally along the receiving slot until the clamp and the base plate are engaged comprises:
sliding the clamp distally along the receiving slot until a peg of the clamp abuts a stop that is adjacent a distally directed end of the receiving slot.

21. A tool for attaching a clamp to a base plate that is affixed to a fan blade, the tool comprising:
an elongated arm, wherein the elongated arm is telescoping;
a pivoting assembly coupled to a second end of the elongated arm; and
a curved beak coupled to the pivoting assembly, wherein the curved beak comprises:
a proximal portion coupled to the pivoting assembly, and
a distal portion that comprises a pointed tip configured to be inserted into an eye of the clamp.
